(19) United States
(12) Patent Application Publication
(10) Pub. No.: US 2010/0310041 A1
(43) Pub. Date: Dec. 9, 2010

(54) X-Ray System and Methods with Detector Interior to Focusing Element

(76) Inventors: William L. Adams, Powell, OH (US); Stephen I. Shefsky, Brooklyn, NY (US)

Correspondence Address: THERMO FINNIGAN LLC, 355 RIVER OAKS PARKWAY, SAN JOSE, CA, 95134, US

(21) Appl. No.: 12/793,264

(22) Filed: Jun. 3, 2010

Related U.S. Application Data
(60) Provisional application No. 61/183,860, filed on Jun. 3, 2009.

(51) Int. Cl. G01N 23/223

(52) U.S. Cl. 378/45

(57) ABSTRACT

An X-ray fluorescence instrument in which x-rays are directed from a source onto a sample by a focusing element. Fluorescence from the sample is detected by an x-ray detector disposed entirely within a volume “interior” to the focusing element, as defined in the description of the invention. A second focusing element may collect emission by the sample and direct it monochromatically, over a large opening angle, onto the x-ray detector. Methods for applying the instrument, particularly for the quantification of sulfur and other contaminating elements in lubricants and fuel are also provided.

The present application claims priority from U.S. Provisional Patent Application Ser. No. 61/183,860, filed Jun. 3, 2009, which is incorporated herein by reference.

### TECHNICAL FIELD

The present invention relates to a device configuration, and to methods, for concentrating x-ray radiation for illuminating a sample, and for detecting x-rays subsequently emitted by the sample, in a compact device. Sensitivity enhancements provided are of particular advantage in x-ray fluorescence applications such as the measurement of sulfur concentration in petroleum.

### BACKGROUND ART

The design of x-ray fluorescence (XRF) systems imposes compromises among x-ray beam power, spectral filtering, and collimation of radiation impinging upon the surface of a sample, on the source side, along with detector acceptance solid angle, background scatter, and spectral interference due to various elements in the sample, on the detection side. Hand-held, and portable, instruments have the additional constraints of weight, battery size, and safety. The tradeoffs become more difficult when x-ray lines of lower energy, such as arise in the detection of light elements, are measured, or when very small spots are required to identify contaminants in components such as in an electrmic circuit board.

One application of XRF techniques that is particularly illustrative in the present context, and to which the present invention described below may be applied with particular advantage, is that of measuring sulfur in petroleum and coal. Both energy-dispersive XRF (ED-XRF) and wavelength-dispersive XRF (WD-XRF) have been employed in this context. Regulatory limits for sulfur in fuels and lubricants have become increasingly stringent in recent years. Prior to 1993, the limit set by the US Environmental Protection Agency for sulfur in diesel fuel was 5000 ppm. The limit was subsequently lowered to 500 ppm, and is transitioning to 15 ppm (so-called “ultra-low-sulfur diesel”, or “ULSD”), in view of which refiners are typically required to reduce sulfur to below 10 ppm. Current regulatory limits in Japan and the European Union are of the same order, with experts forecasting future reductions to 5 ppm in the near term. The U.S. limit for sulfur in gasoline now stands at 30 ppm, while limits as low as 10 ppm are in effect in Japan, Germany, Sweden, and Finland. While currently less stringent, U.S. regulatory limits for jet fuel, off-road diesel, and heating oil may eventually be pushed toward “ultra-low-sulfur.”

Because of the tighter regulatory limits, test methods have had to become more precise at low concentrations. Older ED-XRF models provided detection limits of 5-20 ppm, however these no longer satisfy present or future needs of the petroleum industry, and instruments must now provide sub-ppm detection limits. Several ED-XRF instruments are currently sold for sulfur-in-oil analysis, including bench-top models. WD-XRF systems that provide sub-ppm sulfur detection limits are full-sized laboratory instruments. These systems are generally high-power (1 to 4 kilowatts) and heavy (400 to 550 kilograms).

In typical current systems, such as depicted in FIG. 1, a detector 2 is placed in a position that is free of direct radiation from the source (such as x-ray tube 3), and, at the same time, close enough to inspected surface 4 as to receive a significant portion of the fluorescent x-rays 5. Inspected surface 4 may also be referred to, herein, and in any appended claims, as either a “sample” or a “target.” FIG. 1 depicts an example of a prior art configuration that uses a filter 6 to minimize unwanted portions of the x-ray spectrum, a collimator 7 to reduce the size of beam 8, as may be preferred, in certain applications, to reduce background. Detector 2 is set off to the side where it can capture some of the fluorescent x-rays emitted from the target. Systems such as depicted in FIG. 1 impose power requirements that make them, under certain circumstances, highly undesirable. In particular, in the configuration of FIG. 1 the interposition of filter 6 and collimator 7 reduce, to a small fraction, the portion of the x-rays generated at anode 1 of x-ray tube 3 that reach the sample 4—typically less than 0.1% of the total radiation generated at the anode. Because detector 2 is located off to the side, only a small fraction, of the order of 1%, of the total amount of fluorescent x-rays 5 generated by the irradiated area is intercepted by the detector.

A significant challenge to XRF instrumentation for the detection of sulfur in oil, and in other low energy applications, is that of background signal reduction, so that requisite detection limits may be met. One stratagem applied to reduce background is described with reference to FIG. 2. According to that stratagem, primary x-rays 10 are polarized via a polarizing target 12 (in this case, highly-oriented pyrolytic graphite (HOPG)) before incidence on the sample at an angle of ˜90°. FIG. 2 depicts such a prior art configuration, incorporated in an energy-dispersive polarizing XRF (EDPXRF) instrument. Fluorescent x-rays are then detected at a further displacement of ˜90°, thereby significantly reducing background due to scatter. The drawback to this technique is the loss of available solid angle, thus an inevitable compromise arises between solid angle and background suppression.

U.S. Pat. No. 7,634,052 (Grodzins), issued Dec. 15, 2009, and incorporated herein by reference, teaches a two-stage converter/concentrator, shown in FIG. 3 and designated generally by numeral 20, for x-ray spectrometers, that is designed to develop a monochromatic x-ray beam from a standard x-ray tube 3. One embodiment of the Grodzins invention uses a conventional highly-oriented pyrolytic graphite (HOPG) focusing element 39 both to improve the concentration of the x-ray beam at the point on the target that is being examined and, at the same time, to monochromatize the energy by using the Bragg diffraction capabilities of a layer of crystalline material on the surface of a appropriately shaped cylindrical focusing tube. The configuration depicted in FIG. 3, however, leaves the detector 2 located off to the side of the target 4 in a position where it still receives only a small portion of the fluorescent x-rays generated by the beam.

### Summary of Inventive Embodiments

In accordance with preferred embodiments of the invention, there is provided an x-ray fluorescence instrument for characterizing a sample. The instrument has a point-like source of x-rays and a focusing element for directing x-rays from the point-like source onto a focal region on the sample and creating an envelope of focusing radiation. Finally, the instrument has an x-ray detector disposed such that any slice of the detector in any plane is interior to a projection of the envelope of focusing radiation onto that plane. The instrument may have a beamstop disposed along a central axis between the source and the detector, and the beamstop may form an integral part of the detector housing.

In other embodiments of the invention, the detector may be energy-resolving, and may be disposed within a detector housing that is substantially confined to a volume interior to the focusing element. The interior surface of the focusing element may be characterized by a log-spiral geometry with respect to the anode spot, and, more generally, may be cylindrically symmetrical about a central axis. The interior surface may be characterized by multiple sections, disposed about a central axis, nested concentrically, or stepped along the central axis.

The focusing element may be adapted to serve as a monochromator of x-ray radiation, and, more particularly, may serve as a secondary emission surface. The interior surface may be coated with a crystalline material or a quasicrystalline material, such as highly-oriented pyrolytic graphite. Alternatively, the interior surface may be a substantially pure elemental metal. A further focusing element may be provided for directing emission from the sample on the detector, and for spectrally filtering the detected emission.

In yet other embodiments of the invention, a second focusing element is provided for directing emission by the sample onto the x-ray detector. The second focusing element acts may serve as a wavelength-dispersive x-ray monochromator.

In accordance with another aspect of the invention, a method is provided for exciting and detecting x-ray fluorescence from a sample. The method has steps of:
a. generating a beam of x-rays;
b. directing the beam of x-rays onto a sample by means of a focusing element characterized by an interior surface, the focusing element defining a volume interior to the focusing element; and
c. detecting x-rays emitted by the sample at a position disposed entirely within a volume interior to the focusing element.

In accordance with yet another aspect of the invention, a method is provided for detecting a target element within a sample. The method has steps of:
a. generating a beam of x-rays adapted for exciting fluorescence characteristic of the target element;
b. directing the beam of x-rays onto the sample by means of a focusing element characterized by an interior surface, the focusing element defining a volume interior to the focusing element;
c. concurrently monochromating the beam of x-rays prior to incidence upon the sample; and
d. detecting x-rays emitted by the sample at a position disposed entirely within a volume interior to the focusing element.

In other embodiments, the step of monochromating may include reflecting the beam of x-rays from a secondary target, and the secondary target may include silver as a surface material. The method may additionally include focusing fluorescent x-rays emitted by the sample onto a detector and monochromating fluorescent x-rays emitted by the sample.

### BRIEF DESCRIPTION OF THE DRAWINGS

The foregoing features of the invention will be more readily understood by reference to the following detailed description, taken with reference to the accompanying drawings, in which:

FIG. 1 is schematic depiction of a prior art X-ray fluorescence (XRF) system;

FIG. 2 depicts another prior art XRF system, employing a polarizing crystal;

FIG. 3 depicts yet another prior art XRF system, this system employing a HOPG focusing and monochromating element;

FIG. 4 is a cross-sectional view of a configuration, in accordance with an embodiment of the present invention, in which an x-ray detector is disposed coaxially with a focusing element; and

FIG. 5 is a cross-sectional view of a configuration, in accordance with an embodiment of the present invention, in which optics are employed to collect emission by the sample and to relay them, with energy selectivity, to the detector.

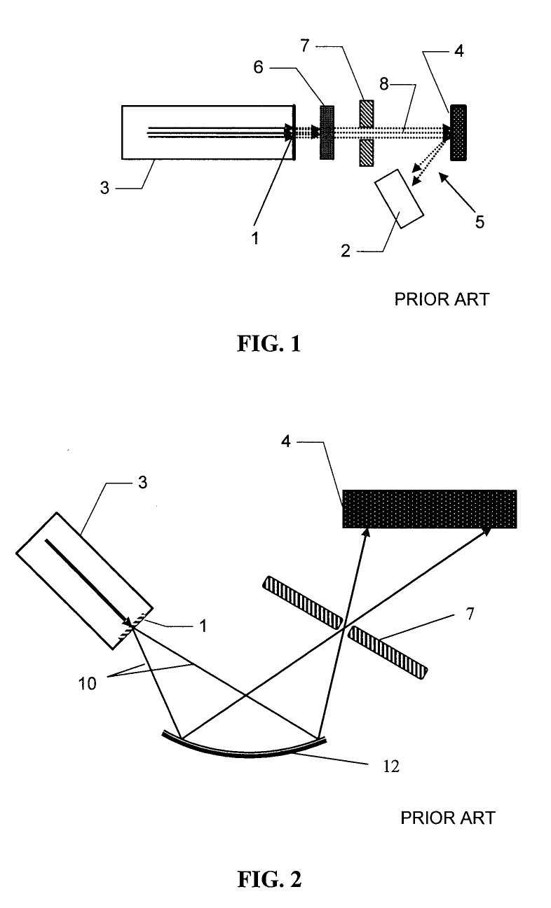

### DETAILED DESCRIPTION OF SPECIFIC EMBODIMENTS

Basic features of embodiments of an x-ray system, in accordance with the present invention, are now described with reference to FIG. 4. A focusing system, designated generally by numeral 39, and a detector 34, are substantially coaxial with respect to a central axis 40, whatever shape of focusing element may be employed. Such configurations advantageously utilize a higher percentage of the x-rays emitted by the x-ray source than in typical systems, simultaneously monochromating and focusing the beam and thereby reducing the fraction of x-rays that contribute to the detection background, moreover, the detector is located at an ideal location. As used herein and in any appended claims, the verb “monochromating” will mean substantially confining the spectrum of radiation to a narrow energy band. The embodiment shown in FIG. 4 utilizes a HOPG crystal on the surface 32 of a focusing element 39 which, within the scope of the present invention, may be formed in various shapes, as further described below. The term HOPG “crystal” will be employed herein to refer to highly-oriented pyrolytic graphite material made up of crystallites, which, while substantially aligned with the surface, also contain a small random component. Such materials may be referred to herein, and in any appended claims, as “quasicrystalline” materials.

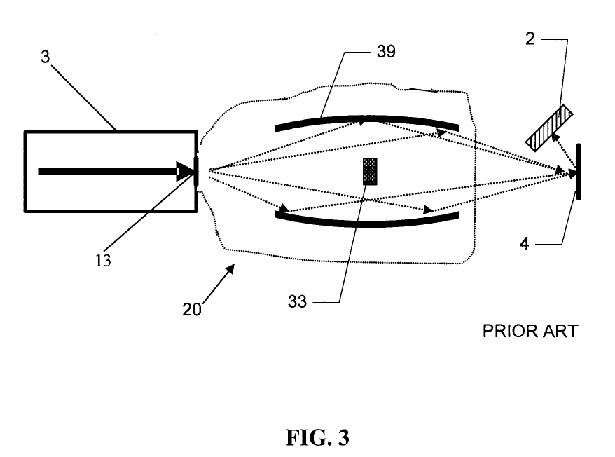

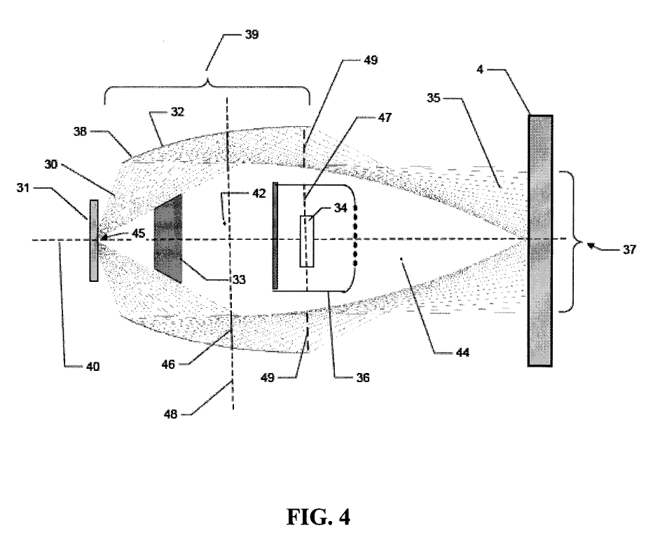

As discussed above with respect to the prior art XRF system depicted in FIG. 3, HOPG crystals on the surface 32 of a focusing element 39 may serve to accomplish both the concentration of the x-rays and formation of a monochromatic beam of x-rays. The HOPG material is available from a number of sources and can be applied to precision machined surfaces. These materials make use of the Bragg diffraction of x-rays in a crystalline material.

Bragg scattering occurs when an x-ray beam impinges on a crystal lattice structure at an angle 9 with respect to the surface of the material. According to the Bragg equation, entry angle 0, which is equal to the exit angle, is related to the x-ray energy E in keV and the spacing of the lattice structure of the crystal d in angstroms (˜3.35 Å in HOPG) by the equation

2d sin θ=12.4 n/E, (1)

where the diffraction order n>1, and is typically 1 or 2. If the angle of incidence deviates from θ, the x-rays pass through the crystal and are absorbed or scattered by the backing material. Thus, for a specific energy E the x-rays are scattered at a precise exit angle of θ with respect to the surface of the crystal structure. As an example, using HOPG (d=3.35 Å) to focus silver L_{αl} x-rays at E=2.984 KeV by first order diffraction (n=1), θ=38.26 degrees.

It is to be understood that the present invention is not limited to any particular shape of a focusing element 39, nor to particular material properties, such as those of the foregoing system which has been discussed solely by way of example. Focusing element 39 may be referred to as a “cone,” with the understanding that the usage is colloquial, and is not intended to specify a particular geometry. A preferred surface for focusing element 39 is that of a logarithmic spiral (“log-spiral”), given by r=r₀ exp(−φ/ tan θ ), where θ is the Bragg diffraction angle, φ is the polar angle (relative to the central axis), and r₀ is the scale (physical size) factor. A log-spiral surface is preferred in that it satisfies the Bragg condition for an effective point source, and, rather than focus to a point, focuses over an area of sample 4 designated by numeral 37, as shown in FIG. 4. Moreover, it is to be understood that focusing element 39 may be a compound surface, in that the curve parameters, such as rᵢₚ, may be stepped in discrete intervals along axis 40. Alternatively, other profiled diffracting surfaces may be employed, such as Johansson-cut crystals, etc., various of which are discussed in U.S. Pat. No. 6,389,100 (to Verman), and all of which are within the scope of the present invention.

In alternate embodiments of the invention, there may be multiple “cones” 38, which may be coaxial—one nested within another. In one embodiment of the invention, cones are nested such that x-rays passing through one or more inner cones subsequently interact with an exterior cone. In accordance with further embodiments of the invention, there may be multiple segments of cones of differing parameters arranged about the azimuthal angle φ with respect to axis 40. Sections may be arranged around axis 40. In that case, cylindrical symmetry with respect to axis 40 is incomplete. In one embodiment of the invention, there may be two halves of a surface of revolution, with each half characterized by distinct surface parameters. A shutter (not shown) may swivel between the two halves, such that target 10 is periodically irradiated by monochromatic X-rays of distinct energies.

In the embodiment of FIG. 4, x-rays 30 emanate from a point-like x-ray source 45, such as anode 31 of an x-ray tube (not shown), into 2π radians, L e., into the entire forward half-plane, although only the x-rays 30 that are diffracted by the HOPG-coated log spiral sections 38 are shown. Because of the diffraction angle and the configuration of log spiral section 38 of the focusing element 39, the foregoing x-rays (sometimes referred to herein as the primary x-ray beam) are directed toward sample 4 (which may also be referred to, herein, as the “target”).

Surface 32 of focusing element 39 may be a surface of revolution, and thus substantially cylindrically symmetrical about, a central axis 40 which extends through anode 31 (or other portion of the x-ray source) and a centroid, in a transverse plane, of the envelope of focusing radiation. As used herein, the “envelope of diffracted rays” will refer to a cross-section of x-rays 30 as vignetted by a beamstop 33 and as focused by focusing element 39. It is to be understood that surface 32 need not be cylindrically symmetric, and may have breaks in it, within the scope of the invention.

As used herein, a point 42 is “interior to focusing element 39” if, and only if, in any plane 48 transverse to the central axis 40, the point 42 is interior to the projection 46 of the envelope of diffracted rays 35 that are being focused by focusing element 39. The set of all points 42 which are “interior to focusing element 39” is defined to be “the volume interior to focusing element 39.” In accordance with this definition, point 44, for example, is “interior to” focusing element 39, even though surface 32 is truncated further away from sample 4 than the position of point 44.

In preferred embodiments of the present invention, any slice 47 taken through detector 34 lies entirely interior to projection 49 onto the plane of slice 47 of the envelope of diffracted rays 35 focused by focusing element 39. Indeed, in further preferred embodiments of the invention, substantially all of detector housing 36 lies interior to focusing element 39, in the aforesaid sense.

A beamstop 33 may be placed along the central axis 40 to intercept and absorb radiation originating from a source spot 45 which would otherwise strike the detector housing 36 or miss the focusing element 39. Alternatively, beamstop 33 may form an integral part of the detector housing 36. Detector 34 is preferably energy-resolving. The placement of HOPG sections 32 is also chosen so that the diffracted rays 35 pass detector 34 without interacting with it and illuminate the sample 4. Note also that the sample placement is such that the focusing system may serve to provide illumination over an area 37 rather than at a spot.

While methods described herein in accordance with embodiments of the invention are useful over a range of energy levels, the primary limitations are with respect to size. The configuration of FIG. 4 shows a detector 34 in a detector housing 36 (in the case shown, a TO-8 package) that establishes the internal chamber size necessary to accommodate the detector 34 without having incident or diffracted x-ray beams impinging on it. The example depicted in FIG. 4 is based on the use of HOPG to focus silver L_{α1} x-rays at E=2.984 keV, with a focusing cylinder of diameter ˜0.8 in. and a length ˜1.5 in. The determining factor is the angle θ and the focusing configuration chosen. As the energy increases the Bragg scattering angle can be determined from Equation 1:

θ=arc sin(6.2n/dE). (2)

For example, when E is 30 keV, θ≈3.5°. Changes in the size of the detector encapsulation to reduce the size, as well as different application objectives, may allow the configuration be useful to higher energies. The example below is designed to take advantage of the L_{α1} line (2.984 keV) of silver to excite the sulfur fluorescent x-rays.

The 2θ Bragg diffraction angle of HOPG for Ag—La (2.984 keV) is about 76.52°. Therefore the solid angle of a point-source monochromator having a polar angle running from θ to 2θ, as depicted in FIG. 4, is a whopping 3.47 steradians. The peak reflectivity of good quality HOPG at this energy is 0.22, so the maximum effective solid angle of this design is a still remarkable 0.76 steradians. By contrast, the source-utilization solid angle of a hand-held XRF instrument is more typically about 0.06 steradians, unfiltered.

In one embodiment of the invention, r₀=2.225 in. (56.5 mm), as defined above, so that the envelope interior to the beam of converging x-rays can reasonably accommodate a TO-8 detector package. The overall length of the HOPG optic thus defined is 0.654 in. (16.61 mm) and the diameter at the mouth is 1.182 in. (30.01 mm). The distance from source spot to sample should be at least 1.5 in. (38.1 mm). The thickness of the HOPG need not exceed 100 μm.

### EXAMPLE

### Measuring Sulfur in Oil

In one embodiment of the present invention, a relatively simple single-surface HOPG optic 39 is used as a monochromator for the source. The monochromator, by conveying only a narrow band of radiation onto the sample surface, serves to eliminate source continuum radiation, which would otherwise be a main cause of detector background. More particularly, in the context of sulfur detection, source continuum (due to bremstrahlung emission in the x-ray tube) may, otherwise, provide unwanted background in the sulfur K_{α}region (˜2.3 keV). By keeping the source energy low, sample backscatter (Compton and Rayleigh) is minimized, which is advantageous in that it might otherwise overwhelm the energy-dispersive detector with counts, or might create excessive background through detector tailing.

A preferred energy range for a monochromatic source is ˜3.0 to ˜3.5 keV, high enough to avoid direct overlap of the backscatter peak with the sulfur peak but also low enough to keep the silicon detector's escape peaks out of the way. This energy range coincides nicely with the Ag-L_{α1} (2.984 KeV), so a readily available silver anode x-ray source may be employed to generate the primary x-ray beam.

The HOPG optic allows collection of a large fraction of the source's output and its direction toward the sample. Detector 34 within detector housing 36 is position along the central axis 40 of the HOPG optic, nested within a pocket formed by the converging source rays 35. This close-coupled sample-to-detector geometry ensures that a good fraction of fluorescent x-rays emitted from the sample 4 will reach detector 34. The basic layout of the geometry is as depicted in FIG. 4.

Efficient use is made of available solid angles of both source and detector. Relative to the coaxial detector with HOPG optic, as taught in accordance with embodiments of the present invention, other schemes may sacrifice a large share of the solid angle. Coaxial detector placement, in accordance with the present invention, can easily utilize source solid angles of 4 steradians or more. Such source usage is 40 to 50 times greater than that of XRF polarization schemes employed in the prior art. With a short distance between sample 4 and detector 34, the present invention may advantageously provide a larger detector solid angle as well.

An alternative to use of a HOPG optic is to use a secondary emitter as a “monochromatic” source. A geometry may be employed that is similar to that described heretofore, but with the HOPG coating is replaced by a secondary emitter, such as silver or tin, i.e., replacing the HOPG with a substantially pure elemental metal. One disadvantage of the secondary emission scheme is poor efficiency, due to the fact that secondary emission is essentially isotropic, thus only a small fraction of those emissions reach the sample. Additionally, fluorescent yield is low (about 5% for Ag-L_{α1}). So, in order to achieve comparable performance, the source power would have to be increased by a large factor, at least an order of magnitude. Another disadvantage is that the secondary emitter is less perfect as a monochromator than HOPG. Thus, scatter of the source spectrum off the secondary emitter adds to the radiation reaching the sample. While HOPG also scatters at off-energies, the scatter at these energies is not preferentially directed toward the sample the way it is at the monochromator energy. Nevertheless the secondary emission scheme retains the virtues of simplicity, low expense, and relaxed precision requirements relative to the HOPG optic scheme. If additional tube power is available, as in a bench-top system, then the secondary emitter configuration may be attractive.

In another exemplary application, where light elements are to be detected, as in cement, a preferred anode target material is not Ag or Sn, which produce a number of low-energy L x-rays, but, rather, one or more light elements, such as Cl, K or Ca, that result in nearly monochromatic K x-rays in a comparable energy region.

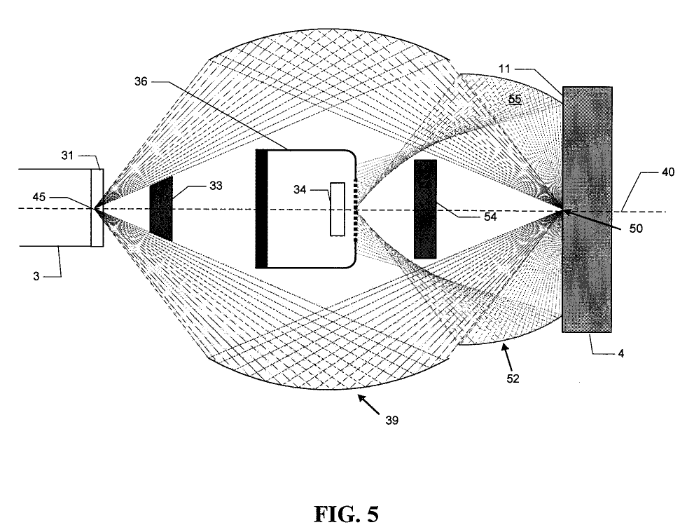

In accordance with other embodiments of the present invention, X-ray (or other) emission by the sample 4 may be collected over a larger opening angle and relayed, achromatically or with energy resolution, onto detector 34. One such embodiment is depicted in FIG. 5, by way of example, and without limitation. In the embodiment shown, signal to noise is enhanced by monochromating sample emission 55 using a focusing element 52, preferably log-spiral, disposed between the sample 4 and the detector 34. A second beamstop 54 may be interposed between the sample and the detector so as to limit detected emission to a range of wavelengths diffracted into detector 34 by focusing element 52.

Thus, in accordance with embodiments of the invention described with reference to FIG. 5, two x-ray optic focusing elements are employed. The first focusing element 39 delivers monochromatic radiation from x-ray source 31 to a single “point” 50 on surface 11 of the sample 4. It is to be understood that point 50 refers to a focal region of small, albeit finite, extent. The second focusing element 52 selectively directs fluorescent radiation 55 from the sample surface 11 to the detector 34.

The several components of focusing elements 39 and 52, detector 34, and radiation beamstops 33 and 54 are preferably aligned concentrically along a central axis 40 connecting the x-ray source 3 to a focal spot 50 on the sample surface 11. The x-ray source 3 may be an x-ray tube with a small electron focal spot such that x-rays are emitted from a small area 45 on the tube's anode target 31. The anode target 31 may be silver to produce the Ag-L_{α1} x-ray (2.984 KeV).

In accordance with preferred embodiments, the first focusing element 39 is a point-to-point focusing monochromator. To achieve point-to-point focus with a crystalline material having fixed atomic lattice spacing (and a fixed angle of diffraction θ), the said crystalline material lies on a circular arc connecting the x-ray source spot 45 with the sample focal spot 50. The arc's radius of curvature is determined by the distance between the source spot and the sample focal spot, and by the full angle of scatter 2θ. The arc and the central axis determine a surface of revolution upon which the crystalline material is located. For efficient focusing of the source x-rays on the sample surface, the crystalline lattice planes are aligned such that the source-originated rays intersect the lattice planes at an angle approximately equal to the diffraction angle θ. So, the vector normal to the crystalline lattice plane bisects the full angle of scatter 2θ. In general, then, the crystalline lattice planes are not aligned with the surface upon which the crystalline material is located. A focusing element of this kind may be realized as an assembly of Johansson-cut crystals, or by applying planar crystalline sheets (of HOPG, for example) to a surface that has been scored, grooved, or blazed to align the crystalline lattice planes for proper focus.

In order to selectively focus the Ag-L_{α1} radiation (2.984 KeV) with HOPG, the angle of scatter 2θ equals about 76.5 degrees. To select the sulfur K_{α1} x-ray (2.308 KeV) with HOPG, in another instance, the angle of scatter 2θ equals about 106.4 degrees.

In a preferred embodiment, the first focusing element 39 covers the full surface of revolution about the central axis 40. But even with periodic gaps and discontinuities it is possible to achieve highly efficient delivery of the source radiation to the sample surface. The second focusing element 52 selectively directs sample-produced fluorescent radiation 55 from the sample 4 to the detector 34 in the manner of a wavelength-dispersive x-ray monochromator. Similar to the first focusing element 39, the second focusing element 52 is cylindrically symmetric and concentric with the central axis 40. This element may be realized with conventional HOPG optics in which the crystalline planes are aligned with a precisely cut and polished surface defined by a log-spiral surface of revolution about the central axis. Ideally, the second focusing element covers the full surface of revolution about the central axis 40. But even with periodic gaps and discontinuities it is possible to achieve highly efficient direction of monochromatic fluorescent radiation from the sample 4 to the detector 34.

A beamstop 33 disposed between the x-ray source 3 and the detector 34 prevents source x-rays from striking the detector directly. Similarly a second beamstop 54 may be located between the sample surface 11 and the detector 34 to intercept sample-scattered radiation which might otherwise strike the detector and increase background.

Detector 34 may be a solid state energy-dispersive pulse counting type, such as a silicon PIN diode or a silicon drift detector. Alternately, detector 34 may be a gas filled type such as a proportional counter, or a solid scintillator. Since the second focusing element 52 functions as a wavelength-dispersive monochromator, detector 34 need not necessarily discriminate by x-ray energy and may operate in current (integrating) mode.

While embodiments of the invention in accordance with FIG. 5 pose particular critical requirements of point-to-point focus and proper alignment of the source, optics, and sample, levels of performance (for signal-to-noise ratio, detection limit, etc.) unique to this configuration may advantageously be achieved. It is to be understood that the present invention is not limited to any particular shape of focusing element 39 or focusing element 52, nor to particular material properties, such as those of the foregoing system which has been discussed solely by way of example. Moreover, it is to be understood that either of the focusing elements 39 and 52 may be a compound surface, in that the curve parameters may be stepped in discrete intervals along axis 40. Alternatively, other profiled diffracting surfaces may be employed, such as Johansson-cut crystals, etc., various of which are discussed in U.S. Pat. No. 6,389,100 (to Verman), which is incorporated herein by reference, and all of which are within the scope of the present invention. In particular, a point-to-point focusing monochromator may employ an elliptical focusing element in which the d-spacing varies in a controlled manner; laterally graded multilayers and laterally graded crystals (such as Si—Ge) are particular examples, provided without limiting intent.

The embodiments of the invention described above are intended to be merely exemplary; numerous variations and modifications will be apparent to those skilled in the art. As an example of such a variation, it should be understood that the advantageous use of the geometry taught and claimed within the scope of the present invention encompasses various x-ray applications and is not limited to fluorescence spectroscopy. All such variations and modifications are intended to be within the scope of the present invention as defined in any appended claims.

We claim:

1. An x-ray fluorescence instrument for characterizing a sample, the instrument comprising:
a. a point-like source of x-rays;
b. a focusing element for directing x-rays from the point-like source onto a focal region on the sample and creating an envelope of focusing radiation, the focusing element characterized by an interior surface; and
c. an x-ray detector disposed such that any slice of the detector in any plane is interior to a projection of the envelope of focusing radiation onto that plane.

2. An x-ray fluorescence instrument in accordance with claim 1, wherein the detector is energy-resolving.

3. An x-ray fluorescence instrument in accordance with claim 1, wherein the detector is disposed within a detector housing, the detector housing substantially confined to a volume interior to the focusing element.

4. An x-ray fluorescence instrument in accordance with claim 1, wherein the interior surface of the focusing element is characterized by a log-spiral geometry with respect to a central axis.

5. An x-ray fluorescence instrument in accordance with claim 1, wherein the interior surface of the focusing element is cylindrically symmetrical about a central axis.

6. An x-ray fluorescence instrument in accordance with claim 1, wherein the interior surface of the focusing element is characterized by multiple sections.

7. An x-ray fluorescence instrument in accordance with claim 6, wherein the multiple sections are disposed about a central axis.

8. An x-ray fluorescence instrument in accordance with claim 1, wherein multiple focusing elements are nested concentrically.

9. An x-ray fluorescence instrument in accordance with claim 6, wherein the interior surface of the focusing element is stepped along the central axis.

10. An x-ray fluorescence instrument in accordance with claim 1, wherein the focusing element is adapted to serve as a monochromator of x-ray radiation.

11. An x-ray fluorescence instrument in accordance with claim 10, wherein the interior surface serves as a secondary emission surface.

12. An x-ray fluorescence instrument in accordance with claim 10, wherein the interior surface is coated with a crystalline material or a quasicrystalline material.

13. An x-ray fluorescence instrument in accordance with claim 10, wherein the interior surface is coated with highly-oriented pyrolytic graphite.

14. An x-ray fluorescence instrument in accordance with claim 8, wherein the interior surface is a substantially pure elemental metal.

15. An x-ray fluorescence instrument in accordance with claim 1, further comprising a beamstop disposed along a central axis between the source and the detector.

16. An x-ray fluorescence instrument in accordance with claim 15, further comprising a beamstop wherein the beamstop is an integral part of the detector housing.

17. An x-ray fluorescence instrument in accordance with claim 1, further comprising a second focusing element for directing emission by the sample onto the x-ray detector.

18. An x-ray fluorescence instrument in accordance with claim 17, wherein the second focusing element comprises a wavelength-dispersive x-ray monochromator.

19. An x-ray fluorescence instrument in accordance with claim 17, further comprising a second beamstop interposed between the sample and the x-ray detector.

20. A method for exciting and detecting x-ray fluorescence from a sample, the method comprising:
a. generating a beam of primary x-rays;
b. directing the beam of primary x-rays onto a sample by means of a focusing element characterized by an interior surface, the focusing element defining a volume interior to the focusing element; and
c. detecting, at a set of positions disposed entirely within a volume interior to the focusing element, fluorescent x-rays emitted by the sample.

21. A method in accordance with claim 20, wherein the step of directing the beam of primary x-rays onto a sample further comprises concurrently monochromating the beam of primary x-rays prior to incidence upon the sample.

22. A method in accordance with claim 21, wherein the step of monochromating includes reflecting the beam of primary x-rays from a secondary target.

23. A method in accordance with claim 22, wherein the secondary target is characterized by a surface including silver.

24. A method in accordance with claim 20, further comprising focusing fluorescent x-rays emitted by the sample onto a detector.

25. A method in accordance with claim 20, further comprising monochromating fluorescent x-rays emitted by the sample.
